(19) United States
(12) Patent Application Publication
(10) Pub. No.: US 2012/0234308 A1
(43) Pub. Date: Sep. 20, 2012

(54) Grill System

(76) Inventors: Russell Faulk, Elmhurst, IL (US); Kimberly Thomas, Kalamazoo, MI (US)

(21) Appl. No.: 13/049,372

(22) Filed: Mar. 16, 2011

(51) Int. Cl. A47J 37/07

(52) U.S. Cl. 126/25 R

(57) ABSTRACT

A grill system includes a grill frame and a cooking surface attached to the grill frame. The grill system also includes a solid fuel compartment positioned proximate to the cooking surface. The grill system additionally includes a burner positioned below the solid fuel compartment. Cooking may be accomplished by alternately using only the burner, using only solid fuel placed in the solid fuel compartment, and using both the burner and the solid fuel placed in the solid fuel compartment to heat a common area of the cooking surface without modifying an arrangement of the solid fuel compartment and the burner.

### TECHNICAL FIELD

The present description generally relates to a grill system and a method, generally referred to as a system, of using a grill system.

BACKGROUND

Food may be prepared and cooked in many ways. For example, food may be grilled, smoked, baked, fried, boiled, broiled, barbequed, steamed, and/or served raw. One or more devices may be used to cook food, such as, for example, a grill, oven, stove-top, microwave, and/or open flame.

### SUMMARY

A grill system includes a grill frame and a cooking surface attached to the grill frame. The grill system also includes a solid fuel compartment positioned proximate to the cooking surface. The grill system additionally includes a burner positioned below the solid fuel compartment. Cooking may be accomplished by alternately using only the burner, using only solid fuel placed in the solid fuel compartment, and using both the burner and the solid fuel placed in the solid fuel compartment to heat a common area of the cooking surface without modifying an arrangement of the solid fuel compartment and the burner.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a side perspective view of a grill system.

FIG. 2 is a front view of a grill system.

FIG. 3 is a side view of a grill system.

FIG. 4 is a top view of a solid fuel compartment.

FIG. 5 is a cross-sectional view of the solid fuel compartment in FIG. 4.

FIG. 6 is an elevated side perspective view of a solid fuel compartment.

FIG. 7 is a partial side perspective view of a solid fuel compartment and grill system.

FIG. 8 is a cross-sectional view of a burner.

FIG. 9 is a flow diagram of a method of using a grill system.

### DETAILED DESCRIPTION

Cooking may be performed using a grill or grill system. The use of grills or grill systems may be beneficial to many users who wish to cook outside of their home, and/or who wish to have flexibility in the location of their cooking and/or cooking device. Grills and grill systems may cook food in a variety of ways, and using a variety of fuels.

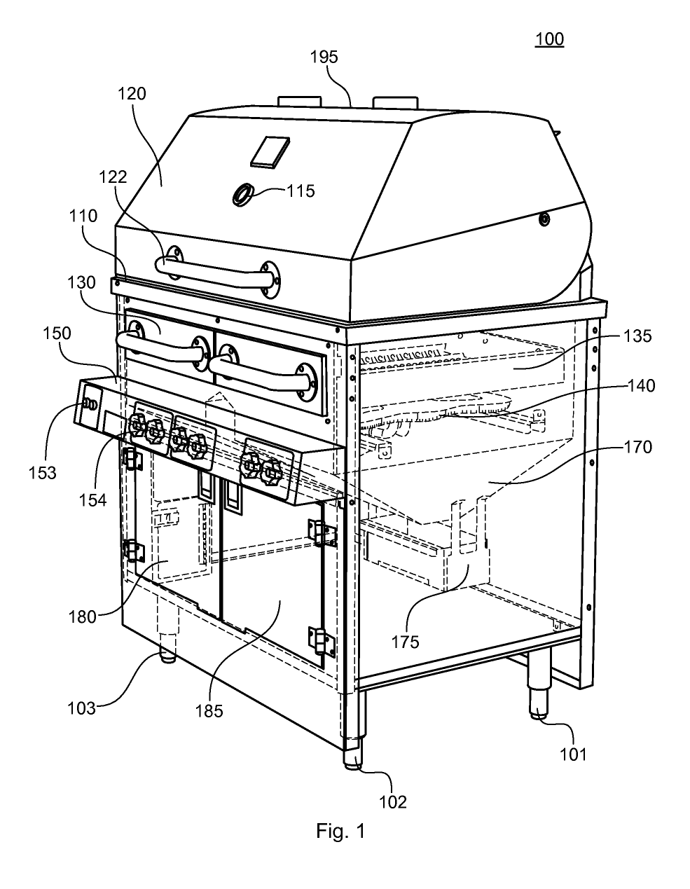

FIG. 1 shows an example of a grill system 100. The grill system 100 may include, for example, one or more components, such as a cooking surface 110, a lid 120, one or more solid fuel compartments 130 and 135, one or more burners 140, a control panel 150, a hopper 170, and/or a cleanout pan 175. The grill system may also include one or more feet 101-103 or wheels, a thermometer 115, a handle 122, igniter switches 153, knobs 154-159, bottom doors 180 and 185, and/or vents 195. The grill system 100 may or may not include side burners, a flip-up warming rack, a rotisserie, and/or a pull-out tray for a propane tank. More or less components may be included in a grill system 100.

The grill system 100 may be useful for heating the cooking surface 110 and/or cooking food. For example, the grill system 100 may be used to grill, sear, roast, smoke, or bake food placed on the cooking surface 110. Other methods of cooking may be possible.

The grill system 100 may be operable to cook food using various fuels. For example, the grill system 100 may cook food using a fluid fuel, such as natural gas, propane gas, or other flammable gases or liquids. The grill system 100 may cook food using a solid fuel such as wood or charcoal. The grill system 100 may cook food using both a fluid fuel and a solid fuel at the same time, or alternatively may cook food using other fuels. The grill system 100 may utilize one or more burner 140 and the solid fuel compartments 130 and 135 without adjusting and/or changing an arrangement of the grill system 100. In some systems, the grill system 100 may be used to cook a piece of food placed on the cooking surface 110 using both a gas burner and charcoal or wood at the same time. For example, a piece of food placed on a cooking surface 110 may be heated and/or subjected to flame from both a fluid fuel and/or a solid fuel, both placed directly under and/or below the piece of food, where the fluid fuel, the solid fuel, and the food may all be in a vertical alignment with each other. Other functions and methods of using the grill system 100 are possible.

The grill system 100 may be or have various shapes. For example, the grill system 100 may generally be shaped like a rectangular, box, cube, parallelepiped, cylindrical, or may be various other shapes or combinations of shapes. In some systems, the grill system 100 may have a generally box-shaped lower section, and a rounded upper portion, such as a rounded upper portion created by a lid 120. In some systems, the grill system 100 may have a full-welded stainless steel frame made of heavy-gauge stainless steel, inside which may reside the solid fuel compartments 130 and 135, the burner 140, the hopper 170, and/or the cleanout pan 175. The frame and/or a lid may individually or jointly create and/or identify the shape of the grill system 100. In other systems, the grill system 100 may be made of and/or have a stainless steel structure that is configured and/or manufactured in other ways, and may or may not be welded. Other shapes are possible.

The grill system 100 may have various dimensions. The grill system 100 may, for example, have a width of between 25 inches and 50 inches, or the width may be greater than 50 inches or less than 25 inches. The grill system 100 may, for example, have a height of between 40 inches and 60 inches, or the height may be greater than 60 inches or less than 40 inches. The grill system 100 may, for example, have a depth of between 15 inches and 30 inches, or the depth may be greater than 30 inches or less than 15 inches. In some systems, the grill system 100 may have a width of about or around 40 inches, a height of about or around 54 inches, and a depth of about 25 inches. In other systems, the grill system 100 may have a width of about or around 30 inches, a height of about or around 50 inches, and a depth of about or around 20 inches. Other dimensions are possible.

The grill system 100 may be supported and/or rest on the ground or against a support structure in various ways. In some systems, the grill system 100 may be supported by one or more feet 101-103. For example, where the grill system 100 is rectangular or generally shaped like a parallelepiped, the grill system 100 may have four feet 101-103 (and a fourth foot note shown) and/or support beams, each attached at or along one of the corner edges of the grill system 100. In other systems, the grill system 100 may have one or more wheels upon which the grill system 100 may rest. The wheels may aid in the transportation of the grill system 100. In other systems, the grill system 100 may be not have feet 101-103, but rather may be box-shaped, rest along edges of front, side, and/or back panels, or have a flat bottom panel upon which to rest. In other systems, the grill system 100 may have a full-welded stainless steel frame made of heavy-gauge stainless steel, upon which the grill system 100 may rest. Other configurations are possible.

As mentioned, the grill system 100 may have one or more cooking surfaces 110, which may also be referred to as grates, cooking grids, grilling surfaces, or cooking surfaces. The cooking surface 110 may be various shapes. For example, the cooking surface 110 may be square, rectangular, circular, or various other shapes or combinations of shapes. The cooking surface 110 may be various sizes. For example, the cooking surface 110 may be rectangular with a width similar to, or slightly smaller than, the width of the grill system 100, and a length similar to, or slightly smaller than, the depth of the grill system 100. The cooking surface 110 may, for example, be ¼ of an inch thick rectangular stainless steel. The cooking surface 110 may, for example, be rectangular with a length, in the direction of the depth of the grill system 100, of between 15 inches and 30 inches, or may be greater than 30 inches or less than 15 inches. The cooking surface 110 may, for example, have a width, in the direction of the width of the grill system 100, of between 15 inches and 80 inches, or may be greater than 80 inches or less than 15 inches. For example, in some systems, the cooking surface 110 may be, for example, 46 inches by 22 inches. The cooking surface 110 may be one or more smaller surfaces, which may or may not be placed together. For example, the cooking surface 110 may be two identical grates placed next to each other to form one larger cooking surface 110. Other sizes, shapes, configurations, and/or dimensions are possible.

The cooking surface 110 may be constructed and/or made in various ways and using various materials. The cooking surface 110 may be made of, for example, steel, stainless steel, porcelain-coated steel, chrome-plated steel, cast iron, porcelain-coated cast iron, other metals, and/or other combinations of materials. For example, the cooking surface 110 may be made from a solid slab of stainless steel, and/or may have one or more apertures, slots, holes, and/or other openings created in the solid slab. In other systems, the cooking surface 110 may be constructed of metal rods welded together or otherwise attached to form a rectangular outer frame, and a series of metal rods welded together or otherwise attached inside the rectangular frame, such as at small intervals and angled relative to the rectangular outer cooking surface frame. In some systems, the cooking surface 110 may be a solid surface without apertures or holes. In systems where the cooking surface 110 is a solid surface without apertures or holes, the cooking surface 110 may be used for teppanyaki-style cooking. Other configurations and constructions are possible.

The cooking surface 110 may be configured, positioned, set, attached to, connected to, or otherwise placed in the grill system 100. For example, the cooking surface may be attached and/or connected to a frame of the grill system 100. In some systems, the cooking surface 110 may be positioned in the grill system 100 such that the cooking surface 110 may be parallel to the ground. For example, the grill system 100 may have a frame, which may include a gap or ledge upon which the cooking surface 110 may be placed and rest. Alternatively or in addition, the grill system 100 may have hooks or other attachments upon which the cooking surface 110 may be hung, so that the cooking surface 110 may lie above the fuel for cooking. The cooking surface 110 may be configured, positioned, set, attached to, connected to, or otherwise placed so as to cover, reside above, be positioned above, and/or receive heat from the solid fuel compartments 130 and 135 and/or the burner 140. The cooking surface 110 may be and/or may identify or relate to the portion of the grill system 100 on which food may be placed to be cooked. Other attachments and/or configurations of the cooking surface 110 with respect to the grill system 100 are possible.

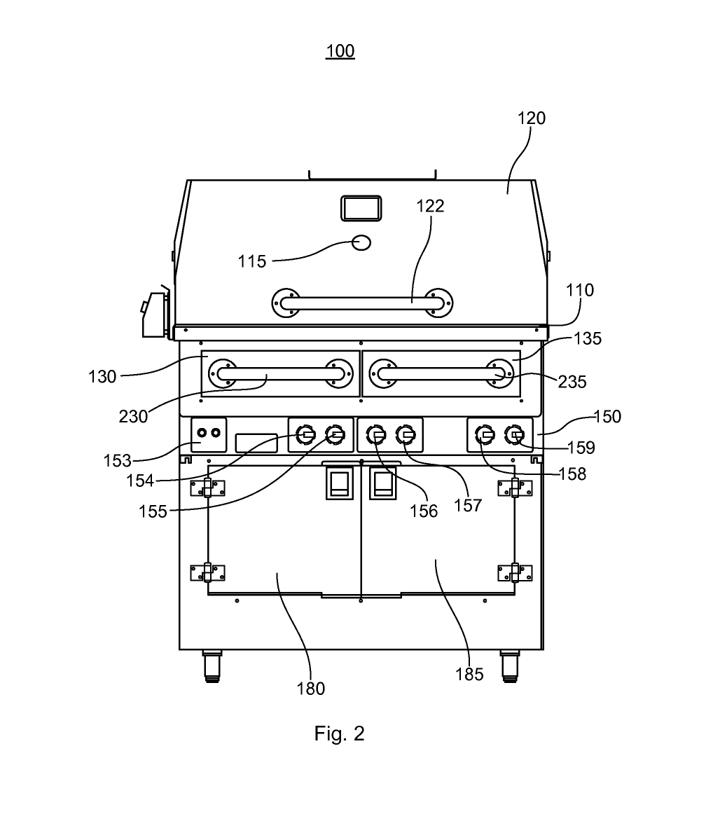

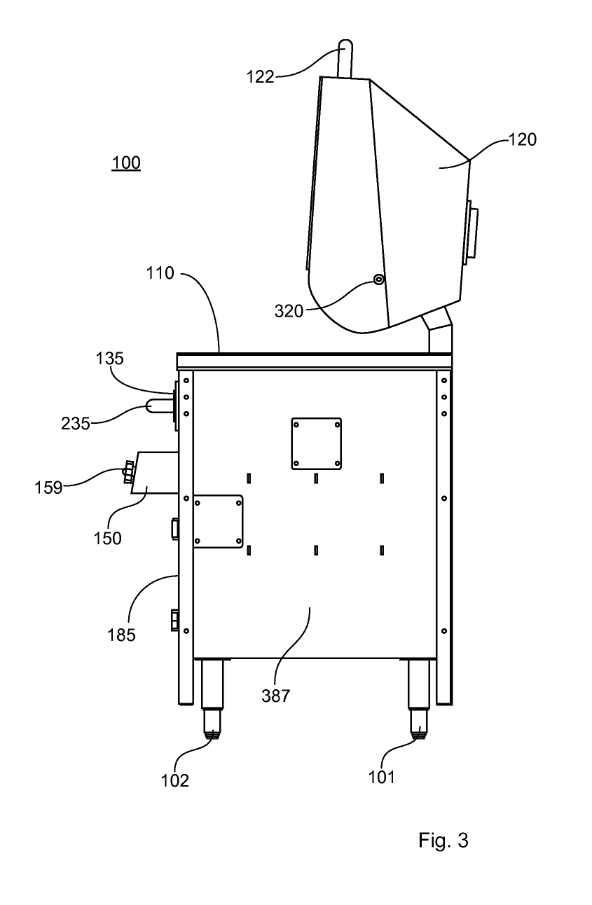

The grill system 100 may also include a lid 120. FIG. 2 shows a front view of the grill system 100 with the lid 120 in the down, or closed, position. FIG. 3 shows a side view of the grill system 100 with the lid 120 in the up, or open, position.

The lid 120 may have various shapes and sizes. For example, the lid 120 may be shaped like a box, rectangle, cube, parallelepiped, three-dimensional trapezoidal, pyramidical, cylindrical, and/or in various other shapes or combinations of shapes. Other shapes are possible. When in a closed position, the lid 120 may have a height above the cooking surface 110. The height of the lid 120 may, for example, be between 10 inches and 20 inches, or may be greater than 20 inches or less than 10 inches. In some systems, the height of the lid is 12 inches. In other systems, the height of the lid is 17 inches. Other heights are possible.

The lid 120 may have an opening which may be various shapes or sizes, such as, for example, the shape and size of the cooking surface 110. Other shapes and sizes are possible. The lid 120 may be configured so that, when in a closed position, the lid 120 may encompass a volume of space bounded by the lid 120 and the cooking surface 110. The volume of space may, for example, accommodate and/or be partially filled by food placed on the cooking surface 110 for cooking. Various other configurations are possible.

The lid 120 may include a handle 122. The handle 122 may, for example, be connected to a front portion of the lid 120, or may be connected to other portions of the lid 120. Other configurations are possible.

The lid 120 may include and/or be attached to the grill system 100, such as using one or more attachment mechanisms 320. The attachment mechanism 320 may, for example, be a screw or bolt which may be fastened to a portion of a frame or other component of the grill system 100. An attachment mechanism 320 may be used on one or both of the sides of the lid 120. For example, an attachment mechanism 320 may be used and/or included on both sides of the lid 120 at corresponding points, such that the lid 120 may be rotated about a rotation axis identified by the corresponding points. Other configurations may be possible.

The lid 120 may be moved back and forth from the closed position to the open position. For example, the lid 120 may be moved to the open position to facilitate placing the food on the cooking surface 110 and/or removing food when it is cooked. The lid 120 may then be moved to the closed position, for example, to keep heat from the solid fuel compartments 130 and 130 and/or the burner 140 contained and/or concentrated on an interior portion of the grill system 100. The handle 122 may be grasped and/or lifted or lowered, which may facilitate and/or assist in the movement of the lid 120. Movement of the lid 120 may be affected by the attachment mechanism 320. For example, the lid 120 may rotate from the closed position to the open position around the rotation axis where the attachment mechanism 320 connects the lid 120 to the rest of the grill system 100. Various other configurations are possible.

The lid 120 and/or handle 122 may be made of various materials, such as steel, stainless steel, porcelain-coated steel, chrome-plated steel, cast iron, porcelain-coated cast iron, other metals, and/or other combinations of materials. Other materials and/or constructions are possible.

As mentioned, the grill system 100 may include a thermometer 115. The thermometer 115 may, for example, be connected to, attached to, and/or otherwise used with the lid 120. The thermometer 115 may measure a temperature on the inside of the lid 120, and may display the measured temperature to an outside of the lid 120. The temperature measured by the thermometer 115 may indicate a temperature at or near which food placed on the cooking surface 110 and inside the lid 120 is being cooked at. In some systems, no thermometer 115 may be included. Other configurations and placements are possible.

As mentioned, the grill system 100 may include one or more solid fuel compartments 130 and 135. The solid fuel compartments 130 and 135 may be attached to, connected to, and/or otherwise inserted into or through a frame of the grill system 100. In some systems, the grill system 100 may include two solid fuel compartments 130 and 135 which may be positioned adjacent and/or side-by-side to each other. In other systems, the grill system 100 may have one solid fuel compartment which may extend across nearly an entire width of the grill system 100, and/or may be as wide as the combination of two solid fuel compartments 130 and 135. In other systems, the grill system 100 may have three or more solid fuel compartments 130. In some systems, the number of solid fuel compartments 130 may depend on a size of the grill system 100, frame or outer boundary of the grill system 100, and/or the number of burners 140. More or less solid fuel compartments may be included.

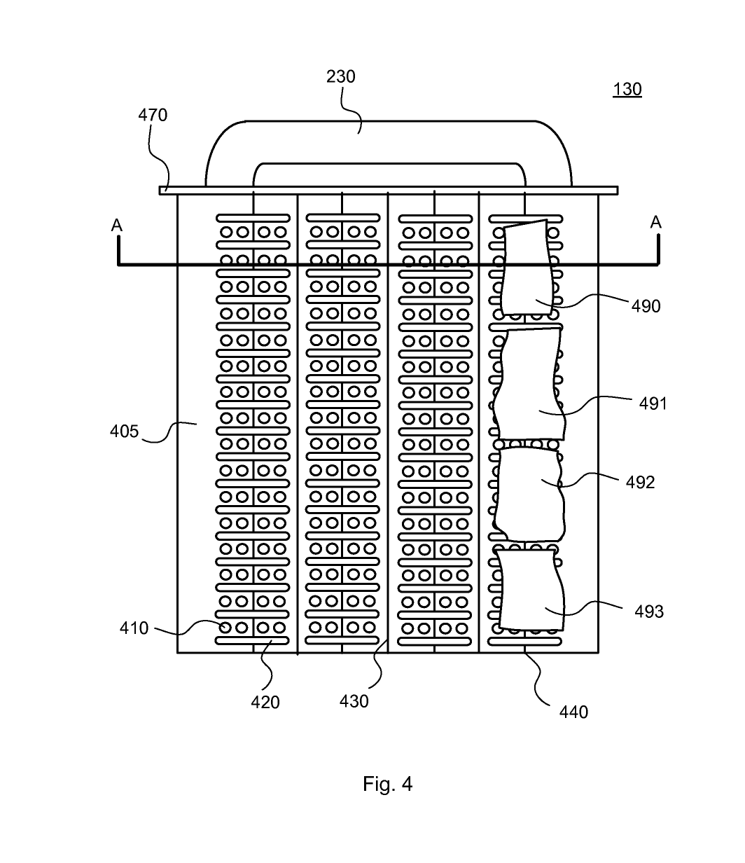

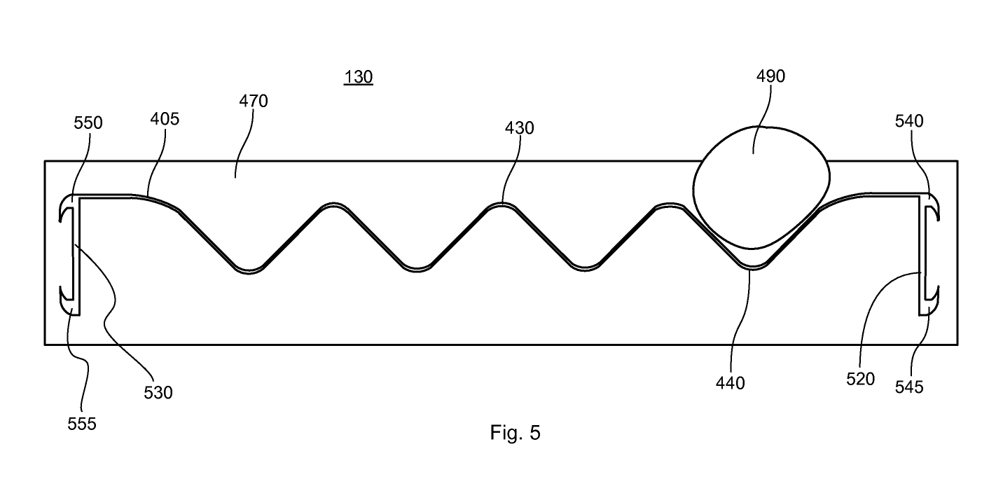

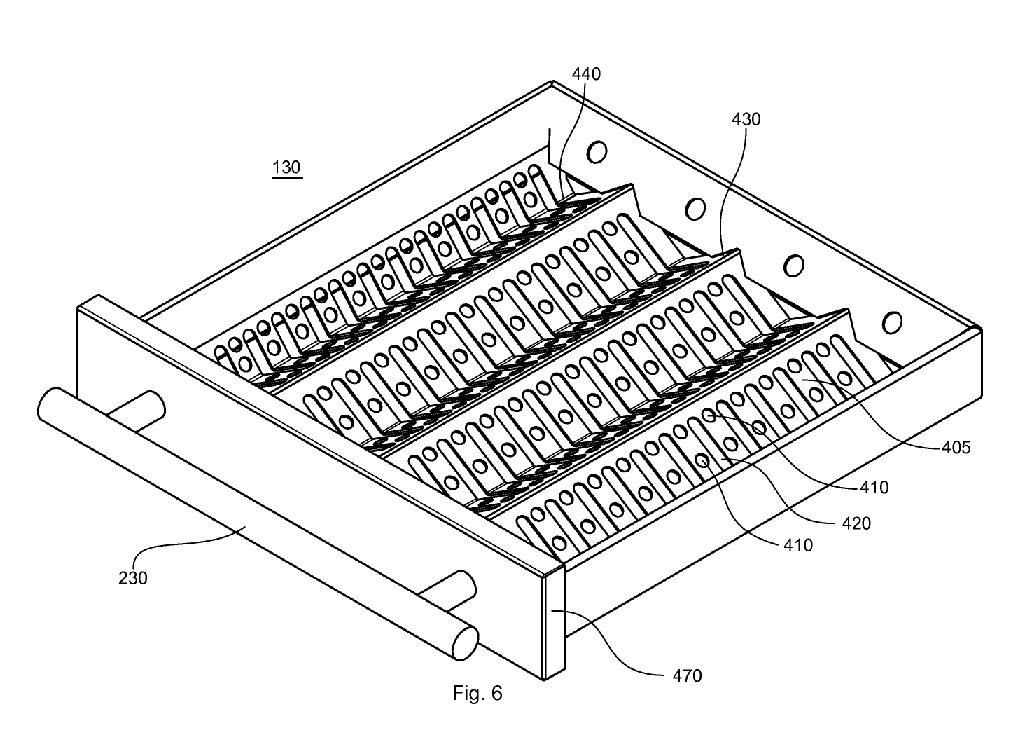

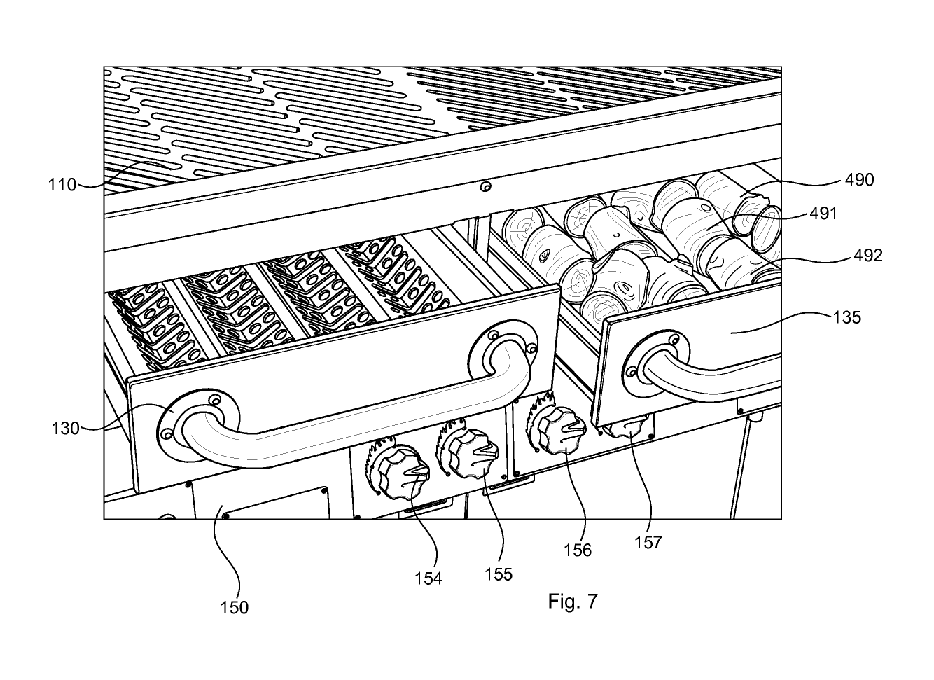

FIG. 4 illustrates a top view of the solid fuel compartment 130. FIG. 5 illustrates a cross-sectional view of the solid fuel compartment 130 in FIG. 4 along the line A-A. FIG. 6 shows an elevated side perspective view of a solid fuel compartment 130 without any solid fuel in it. FIG. 7 shows a top perspective view of a portion of the grill system 100 and solid fuel compartment 130.

The solid fuel compartment 130 may be made of various materials. For example, the solid fuel compartment 130 may be made of stainless steel. In other systems, the solid fuel compartment 130 may be made of iron, steel, porcelain, other metals, and/or other combinations of materials. In systems where more than one solid fuel compartment 130 are included in the grill system 100, each of the solid fuel compartments 130 may be made of the same materials, or any of the solid fuel compartments 130 may be made of different materials.

The solid fuel compartment 130 may be various shapes and/or sizes. The solid fuel compartment may, for example, be box shaped, semi-cylindrical, cylindrical, spherical, parallelepiped, pyramidal, or various other shapes or sizes. The solid fuel compartment 130 may, for example, be box shaped with a width of between 10 inches and 30 inches, or greater than 30 inches or less than 10 inches. The solid fuel compartment 130 may have a depth similar to, or slightly smaller than the depth of the grill system 100 and/or a frame of the grill system 100. The solid fuel compartment 130 may have a height which may be, for example, between 1 inch and 5 inches, or may be greater than 5 inches or less than 1 inch. Other shapes and/or dimensions are possible.

In some systems, the solid fuel compartment 130 may be or resemble a drawer with a bottom such as bottom 405 and a handle such as handle 230. In some systems, the solid fuel compartment 130, or drawer, may sit on top of rails in the grill system 100, which may be positioned below the solid fuel compartment 130. The rails may be rods or other devices which may reside and/or be positioned below the solid fuel compartment 130 to support the solid fuel compartment 130. The rails may have vertical sides which may be spaced apart at a distance larger than the width of the solid fuel compartment 130. The vertical sides may aid in guiding the drawer or solid fuel compartment 130 into the grill system 100. In some systems, one or more rails may also be placed above the solid fuel compartment 130. Rails positioned above the solid fuel compartment 130 may aid in securing the solid fuel compartment 130 in the grill system 100 and/or prevent the solid fuel compartment 130 from tilting.

In alternative systems, one or more sliding devices, such as tracks 520 and 530, may be included with the solid fuel compartment 130. In some of these configurations, the solid fuel compartment 130 may be inserted and/or slid into the grill system 100, such as through an opening in the front of the grill system 100. In these configurations, the grill system 100 may have protrusions or other attaching components which may fit into the tracks 520 and 530. In some other systems, the tracks 520 and 530 may be on the grill system 100, and the attaching components may be on the solid fuel compartment 130. The sliding devices of the solid fuel compartment 130 may aid in using the solid fuel compartment 130.

The solid fuel compartment 130 may be moved, such as sliding the solid fuel compartment 130 along the rail and/or using the sliding devices, from a position where the solid fuel compartment 130 is completely inserted into the grill system 100, to a position where the solid fuel compartment is partially or completely exposed from a portion of the grill system 100, in a manner similar to opening or closing a drawer on a desk. In an open position, solid fuel may be inserted into the solid fuel compartment 130. After solid fuel has been inserted, the solid fuel compartment 130 may be moved, such as slid, back into a closed position, where a front panel 470 of the solid fuel compartment 130 may be, or may nearly be, flush with a front of the grill system 100. Other components, configurations and/or methods of moving a solid fuel compartment 130 and/or sliding devices are possible.

The bottom 405 of the solid fuel compartment 130 may be wavy, corrugated, perforated, bumpy, and/or otherwise uneven. For example, the bottom 405 may have grooves, valleys, and/or channels, such as a channel 440. The channel 440 may extend along a portion of, or an entire, width and/or length of a solid fuel compartment 130. One or more channels 440 may be formed and/or exist in the solid fuel compartment 130. The channels 440 may, for example, generally be V-shaped or U-shaped, and/or may represent and/or identify an indentation in the bottom 405. Additionally or alternatively, the bottom 405 may have one or more hills or peaks, such as peak 430. The peak 430 may extend along a portion of, or an entire, width and/or length of a solid fuel compartment 130. One or more peaks 430 may be formed and/or exist in the solid fuel compartment 130. The peak 430 may, for example, generally be the opposite shape of the channel 440. For example, where the channel 440 is V-shaped, the peak 430 may be shaped like an upside-down V. Other configurations are possible.

These channels 440 and peaks 430 may be formed, for example, from or using angled interior planes, or may be formed in other ways. In some of these systems, the channels may be configured and/or designed so that objects, such as logs, wood pieces, sticks, charcoal, coal, and/or other solid fuels may be placed within one or more channels of the solid fuel compartment 130. For example, solid fuel pieces 490, 491, 492, and 493 may be placed in channel 440. The use of channels and/or peaks may, for example, allow for an even and/or controlled distribution of solid fuel in the solid fuel compartment 130. Channels and peaks may be arranged so as to extend from a front of the solid fuel compartment 130 to a back of the solid fuel compartment 130. Alternatively, channels and peaks may be arranged so as to extend from a first side of the solid fuel compartment 130 to a second side opposite the first side of the solid fuel compartment 130. The channels and/or peaks may be designed so as to filter or gather large pieces of solid fuel, and/or to allow smaller pieces of solid fuel to pass through openings in the bottom of the solid fuel compartment 130. The channels and/or peaks may be designed and/or configured so that heat may gather and/or be evenly distributed through the solid fuel compartment 130. Other variations are possible. In other systems, the bottom 405 of the solid fuel compartment 130 may be flat and parallel to the ground and/or the cooking surface 110.

The bottom 405 of the solid fuel compartment 130 may have one or more holes, openings, apertures, slots, and/or perforations, such as circular apertures 410 or elongated slots 420. The openings may be various sizes and/or shapes, such as circular, rectangular, oval, square, trapezoidal, or other shapes, and may have sharp or rounded edges. The use of slots 420 may reduce a cost of creating a bottom 405 of the solid fuel compartment 130, in that it may be less expensive to create slots 420 than to create apertures 410. The openings may allow for ash and other small waste from the solid fuel to pass out of the solid fuel compartment 130, such as out of the bottom of the solid fuel compartment 130. The openings may be configured so as to be small enough for charcoal, wood chips, small logs, sticks, and other solid fuel may not fall through the openings.

The apertures 410 and/or slots 420 may be configured and/or arranged in various positions. For example, two circular apertures 410 may be positioned on each side of a channel, forming a line of four consecutive circular apertures 410 in each channel 440. Lines of these four consecutive circular apertures 410 may be placed in alternating positions with longer or elongated slots 420 along an entire length of a channel 440. Apertures and/or slot may be positioned, cut, and/or configured along an angled or flat bottom 405 of a solid fuel compartment 130, and/or along one or more side walls of the solid fuel compartment 130. In some systems, elongated slots 420 may be perpendicular to channels or peaks, such as V-shaped channels. The elongated slots 420 may each extend through a portion of at least one of the V-shaped channels. In some systems, only elongated slots 420 or circular apertures 410 are used. In some systems, many different types of openings are used and/or are patterned in many different ways. Other configurations are possible.

In some other systems, the solid fuel compartments 130 and 135 may or may not be wavy and/or have apertures or slots. In some systems, the solid fuel compartments may be or may resemble a drawer or box with a grate on the bottom of it. The bottom grate of the solid fuel compartment may have small enough openings so that solid fuel may be placed and/or stored in the solid fuel compartments without dropping through the solid fuel compartments. Various other configuration and/or functions are possible.

The solid fuel compartment 130 may be used and/or function to hold various solid fuels. For example, the solid fuel compartment 130 may be used to hold charcoal, wood pieces, logs, sticks, smoking woods, and/or various other solid fuels and/or materials. Various other fuels are possible.

In some configurations, such as configurations where no solid fuel is in the solid fuel compartments 130 and 135, the solid fuel compartments 130 and 135 may be designed to diffuse, transfer, disperse, disseminate, distribute, propagate, scatter, and/or radiated heat provided by the burner 140 to the cooking surface 110, such as to provide an even or uniform heat distribution to the cooking surface 110. In some of these configurations, perforations, such as the circular apertures 410 and slot 420, and/or channels and peaks such as channel 440 and peak 430 may individually or jointly provide heat diffusing properties and/or may operate as a heat diffusing device for the burners 140. In these configurations, the solid fuel compartments 130 and 135 may be positioned between the one or more burners 140 and the cooking surface 110, such that heat from the fluid fuel may be transferred through the apertures 410 and/or slots 420 of the solid fuel compartments 130 and 135. The perforations and/or channels in the solid fuel compartments 130 and 135 may individually or jointly create an even distribution of heat and/or flame from the burners delivered to the cooking surface 110. For example, perforations and/or channels may be created and/or spaced in an even and/or uniform distribution such that heat and/or flame of from the burner may pass through the perforations and/or along the channels. The apertures 410 and/or slots 420 may be configured so that this heat is transferred evenly and/or consistently to all parts of the cooking surface 110, and/or to the food being cooked on the cooking surface 110 using the one or more burners 140.

Alternatively or additionally, the perforations and/or channels may individually or jointly speed ignition of solid fuel placed in the solid fuel compartments 130 and 135, and/or may serve to ignite the solid fuel uniformly. Uniform ignition of the solid fuel may be accomplished, for example, through the utilization of the perforations and/or channels, which may ensure that heat from the burner 140 is evenly and/or uniformly applied to solid fuel positioned in the solid fuel compartments 130 and 135. Other configurations are possible.

The grill system 100 may include one or more burners 140. For example, in some systems, there may be two burners 140. In other systems, the grill system 100 may have three or four burners 140. In other systems, the grill system 100 may have six burners 140. More or less burners 140 may be included in the grill system 100.

The burner 140 may be attached to, connected to, and/or otherwise inserted into or through a frame of the grill system 100. Burners 140 may include and/or use fluid fuels and/or flammable fluids for creating and/or sustaining a flame and/or heat used for cooking. For example, the burner 140 may include and/or use natural gas, propane gas, other flammable gases, flammable liquids, fluid fuels, and/or any other flammable fluids or fluid fuels.

The burner 140 may include, for example, gas or grill burners, flammable fluid components, fluid fuel components, radiation components, heaters, electric heaters, and/or other burners. The burners 140, such as grill burners, may be made of, for example, brass, stainless steel, aluminized steel, cast iron, porcelain-coated cast iron, other metals, and/or other combinations of materials. The burners 140, such as grill burners, may have various shapes and/or sizes. The burners 140, such as grill burners, may, for example, be shaped like the capital letter “H” turned on its side, oval shaped, and/or shaped like a figure-8, bowtie, a bar, or mostly straight. In some systems, the burner 140 may comprise one component such as a gas burner. In other systems, the burner 140 may include and/or refer to more than one gas or grill burner. For example, in some systems, the burner 140 may have enough gas or grill burners to evenly heat an entire area of the cooking surface 110. The burner 140 may have any weight, such as, for example, between 5 and 20 pounds, or greater than 20 pounds or less than 5 pounds. In some systems, for example, a burner 140 may be made form a brass alloy with a low lead content, and may weigh approximately 12 pounds. Other burners 140 are possible.

In systems where the burner 140 includes a gas burner, the gas burner may, for example, be hollow with gas inlet holes and outlet holes or ports. Each of the inlet holes may, for example, be controlled by a separate control on the control panel 150. Other burners 140 and/or configurations are possible.

As mentioned, the burners 140 may be positioned, configured, and/or placed below the solid fuel compartments 130 and 135. This may allow for the burners 140 to be used to ignite, light, and/or otherwise heat any solid fuel in the solid fuel compartments 130 and 135. In configurations where no solid fuel is in the solid fuel compartments 130 and 135, the solid fuel compartments 130 and 135 may be designed to diffuse heat provided by the burner 140 to provide an even heat distribution to the cooking surface 110.

Each burner 140 may, for example, supply and/or deliver cooking power to the cooking surface 110. In some systems, each burner 140 may have one or more control zones. For example, in some systems where a burner 140 is a bowtie burner, the burner may have two control zones, side by side. Each burner 140, and/or each control zone, may deliver between 20,000 British Thermal Units (BTUs) and 30,000 BTUs, or may deliver more than 30,000 BTUs or less than 20,000 BTUs. For example, a burner 140 may be designed to deliver between 22,000 and 25,000 BTUs of cooking power.

In some systems, a grill system 100 may increase a total cooking power by increasing a number of burners 140 and/or control zones. In some systems, the grill system 100 may have a cooking power, from the burners 140, of between 40,000 and 200,000 British Thermal Units (BTUs), or may produce more than 200,000 BTUs or less than 40,000 BTUs. In some systems, the burner 140 may produce 50,000 BTUs, or may produce 180,000 BTUs. Other configurations are possible.

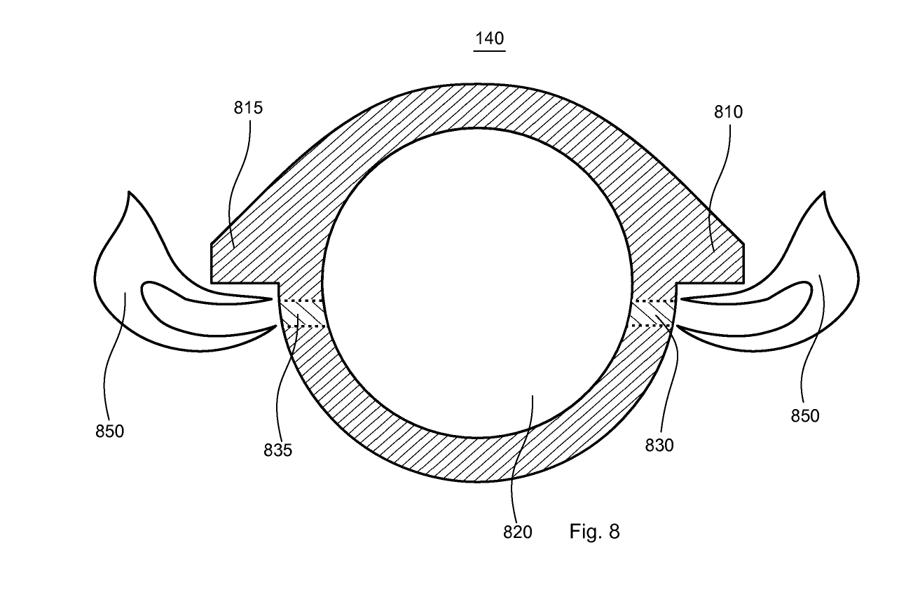

FIG. 8 shows a cross-sectional view of a burner 140 with gas ports 830 and 835 and ledges 810 and 815 over the ports 830 and 835 respectively. The burner 140 may have a hollow central chamber 820, which may represent the hollow burner cavity along its length, through which fluid fuel, such as gas, may flow. The fluid fuel may be emitted through ports 830 and 835, where it is ignited and creates a flame 850. The flame 850 may be larger than and/or extend outward beyond the ledges 810 and 815. The ports 830 and 835 may be placed on opposite sides of the burner 140, or on the same side. One or more ports 830 and 835 may be positioned along a burner 140, such as having one port 830 per designated distance, such as ¼ inch. Other configurations are possible.

The burner 140 may, in some systems, have an angular shape, which may be designed to easily shed ash from the solid fuel compartments 130. As mentioned, the burner 140 may have or otherwise include one or more ledges, hoods, covers, protectors, and/or other deflectors, such as ledges 810 and 815, positioned on an upper portion of the burner 140. Ledges 810 and 815 may be placed above, positioned over, and/or configured so as to protect and/or shield one or more ports 830 and 835 on burners from ash and other debris, such as debris that may fall through apertures 810 on the solid fuel compartment 130. The ledges may be integral with and/or protect the burner 140 from being contaminated with and/or otherwise receiving waste passing through the solid fuel compartments 130 and 135 toward the hopper 170 described below, such as by prevent ash from clogging holes and/or other ports 830 and 835 in the burner 140. The ledges may not prevent waste from passing from the solid fuel compartments 130 and 135 to the hopper 170, but may direct waste away from the burner 140.

The ledges 810 and 815 may be an angled or protruding tab or other extension which may be located directly above the ports 830 and 835, and/or may extend a distance outward from the burner 140, and/or may resemble eaves of a over a window of a house. For example, the ledges 810 and 815 may extend ⅛ inch outward from the burner 140 and/or ports 830 and 835, or may extend a larger or smaller distance from the burner 140. The ledges 810 and 815 may be configured and/or designed so as to be shallow or short enough so that the flame 850 may extend beyond the ledges 810 and 815 and provide heat and/or flame to the cooking surface 110. The design of the solid fuel compartment 130 and/or burner 140 may reduce a risk of flare-ups. In some systems, one or more ledges may be a part of the structure that supports a solid fuel compartment 130. For example, some grill systems 100 may additionally include another burner 140, which may be an ignition burner protected by a ledge that is part of the structure that supports the solid fuel compartments 130 and 135. In some systems, the burners 140 may be easily inserted and/or removed from the grill system 100. Other configurations and types of ledges are possible.

The burners 140 may be controlled and/or adjusted by or through the use of a control panel 150. The control panel 150 may include one or more ignition buttons or switches 153, and/or one or more knobs 154-159. The control panel 150 may be located at the front of the grill system 100, or at various other locations.

The ignition switches 153 may be connected to one or more igniters, such as a spark plug, glow plug, hot surface igniter, or other ignition device, which may provide a necessary spark to ignite any fluid fuel contained in and/or extruded from the burners 140. The use of a hot surface igniter or glow plug may, in some systems, allow for the use of a wiring with a higher temperature rating that other igniters. The ignition switches 153 may be configured so that when the ignition switch 153 is activated, such as by pressing a button or flipping a switch, a spark sufficient to ignite a fluid fuel may be produced.

In some systems, more than one ignition switch 153 may be provided. For example, in some systems, two ignition switches 153 are provided and separately wired to the same igniters and/or fuel sources. In these systems, when one ignition switch 153 fails, a user may use the other ignition switch 153 to light and use the grill system 100. In other systems, multiple ignition switches 153 may be used to ignite different parts of the grill system 100.

In some systems, ignition switches 153 may be integrated and/or incorporated with knobs 154-159 described below. In some systems, activating and/or moving one of the knobs 154-159 to a certain position may trigger an ignition switch and/or igniter, which may provide the flame and/or flame source for the burner 140. For example, in some systems, pushing the knob 154-159 inwards may activate an ignition of the burner. In other systems, activation of the knob may provide fuel to the burner 140 which may be ignited using another burner or an igniter. Other configurations are possible.

In some systems, an ignition switch 153 may ignite one burner, such as an ignition burner. The ignition burner may, for example, be lit by an electronic ignition system. The ignition burner may, in some systems, cross the front of all of the other burners 140. A flame of the ignition burner may be used to light any of the other burners 140. In this way, only one ignition burner may need to be lit with an ignition switch 153, after which all other burners 140 may be lit from the ignition burner.

In some systems, a flash tube may be included and/or used for manual ignition, such as when an electronic ignition fails. The flash tube may be hidden behind a face of one of the solid fuel compartment 130. The solid fuel compartment 130 may be opened, fuel such as gas may be provided to a burner such as an ignition burner, and a match may be held to an end of the flash tube until fuel from the burner ignites. In some systems, ignition switches 153 and/or ignition devices may run on electricity, such as alternating current or direct current. Various other configurations are possible.

The control panel 150 may also include one or more dials, control devices, potentiometers, and/or knobs 154-159. These knobs 154-159 may be moved, such as turned, in one or more directions. In other systems, the knobs 154-159 may be electronic components, buttons, switches, and/or other devices which may be manipulated and used to control one or more heat source, such as a burner 140. Other types of knobs 154-159 are possible.

The knobs 154-159 may, for example, control a rate of flow or a rate of fluid fuel exposed and/or extruded from the burner 140. For example, in a gas burner, the knobs may control how much gas is released from a gas tank or gas source attached to the grill system 100. The knobs 154-159 may additionally or alternatively control an amount of heat and/or flame produced by the burners 140. In some systems, each knob 154-159 controls one component, such as one gas burner, of the burner 140. In other systems, each knob 154-159 controls a portion of an area covered and/or heated by the burner 140. For example, a knob 154 may cover a far left side of a burner 140, such that when the knob 154 is turned on high, heat may be produced on the far left side of the grill system 100 and/or cook food placed on a far left side of the cooking surface 110. Other configurations are possible.

While the grill system 100 is shown as having six knobs 154-159, more or less knobs are possible. The number of knobs may or may not depend on a size of the grill system 100, the number of components and/or burners of the one or more burner 140, and/or the size of the cooking/grilling area or cooking surface 110.

The grill system 100 may include a hopper 170 (sometimes referred to as a funnel). The hopper 170 may be made of various materials. For example, the hopper 170 may be made from a slab or piece of stainless steel, porcelain-coated steel, chrome-plated steel, cast iron, porcelain-coated cast iron, other metals, and/or other combinations of materials.

The hopper 170 may have various sizes and shapes. For example, the hopper 170 may be a trapezoidal, pyramid, cone, rectangular, cylindrical, and/or various other shapes or combinations of shapes. The hopper 170 may be hollow with an opening on a first side of the hopper 170 and an opening on a second side opposite the first side of the hopper 170. An opening on one side of the hopper 170 may generally have a larger area and/or be larger than an opening on the opposite side of the hopper 170. In this way, elements, particles, and/or objects entering the hopper 170 from the larger opening may be transported and/or funneled to a smaller opening Other configurations are possible.

The hopper 170 may have a height between the larger opening and the smaller opening. The height may be various sizes, such as between 4 inches and 20 inches, or greater than 20 inches or less than 4 inches. The height of the hopper 170 may be configured so that the cleanout pan 175 of the grill system 100 may be placed a distance below the burners 140 and the solid fuel compartments 130 and 135. The depth and/or distance of the hopper 170 may, for example, result in a reduced risk of grease fires and/or of flare-ups.

The hopper 170 may be configured so that a larger opening of the hopper 170 has an area and shape which may generally be similar or the same as an area of the cooking surface 110 and/or an area covered by the solid fuel compartments 130 and 135. The larger opening of the hopper 170 may, in some systems, be positioned below the burner 140. The larger opening of the hopper 170 may, in some systems, be aligned with the area of the cooking surface 110 and/or the area covered by the solid fuel compartments 130 and 135, such that any droppings from the solid fuel compartments 130 and 135 and/or the cooking surface 110 may fall into the hopper 170. Other configurations are possible.

The smaller opening of the hopper 170 may be positioned below the larger opening of the hopper 170. The smaller opening may, for example, be aligned above the cleanout pan 175. When solid fuel is burned, the solid fuel compartments 130 and 135 may discard or lose waste, such as ash, grease, and other debris, from the burned fuel. This waste may leave the solid fuel compartments 130 and 135, such as through the apertures 410 and/or slots 420. The waste may pass the burners 140, directed away from the burners 140 by the ledges when necessary, and into the hopper 170. The hopper 170 may collect and transport and/or funnel the waste, such as with the aid of gravity, to the cleanout pan 175.

As mentioned, the grill system 100 may have a cleanout pan 175, which may also be referred to as an ash bin, ash receptacle, waste bin, waste receptacle, cleanout bin, or cleanout receptacle. The cleanout pan 175 may be made of various materials. For example, the cleanout pan 175 may be made from and/or include stainless steel, aluminum or aluminum insert, porcelain-coated steel, chrome-plated steel, cast iron, porcelain-coated cast iron, other metals, and/or other combinations of materials.

The cleanout pan 175 may have various shapes and sizes. For example, the cleanout pan 175 may be rectangular, parallelepiped, cubed, cylindrical, spherical, and/or various other shapes or combinations of shapes. The cleanout pan 175 may have an area much smaller than that of the cooking surface 110 and/or the area covered by the solid fuel compartments 130 and 135. For example, the cleanout pan 175 may be 15 inches wide and 5 inches deep, with a height of 5 inches. The sides of the hopper 170 may be steep, and/or may be deep enough and steep enough so that ash or other waste collected in the hopper 170 falls through to the cleanout pan 175. Other shapes and/or sizes are possible.

The cleanout pan 175 may be removably attached to the grill system 100. For example, the cleanout pan 175 may attach to the hopper 170 in a manner where the cleanout pan 175 is generally secured to the hopper 170. The cleanout pan 175 may be removed from the hopper 170 when the cleanout pan 175 is full. The cleanout pan 175 may be removed from the grill system and any contents in the cleanout pan 175 may be discarded, after which the cleanout pan 175 may be replaced in the grill system 100. Various attachments and/or configurations of the cleanout pan 175 are possible.

In some systems, the grill system 100 may not have a hopper 170. In some of these systems, the cleanout pan 175 may be larger, and/or may catch ash or other waste from the grill system 100 without the aid of a hopper 170. In other systems, the hopper 170 and/or cleanout pan 175 may be combined into one component. The combination hopper 170 and/or cleanout pan 175 may be removable, such as when the combination is full of waste. The hopper 170 and/or cleanout pan 175 may not need to be manipulated at all during the cooking process. Other configurations are possible.

The grill system may have front, side, and/or back panels, such as side panel 387, these front, side, and/or back panels may be made of various materials such as stainless steel, porcelain-coated steel, chrome-plated steel, cast iron, porcelain-coated cast iron, wood, other metals, and/or other combinations of materials. These front, side and/or back panels may be configured, sized, and/or used to cover a portion of the grill system 100. For example, the front, side and/or back panels may cover and/or shield the fluid fuel, the burner 140, the hopper 170, and/or the cleanout pan 175. The front, side, and/or back panels of the grill system 100 may form a bottom interior portion of the grill system 100, where other articles may be stored, such as, for example, a propane gas tank, grilling supplies, a garbage can, and/or other articles. In other systems, no front, side, and/or back panels may be included with the grill system 100. Various configurations are possible.

The grill system 100 may include one or more bottom doors 180 and 185. For example, in some systems, the grill system 100 may include zero or only one bottom door, or may include three or more bottom doors. In other systems, the grill system 100 may have two bottom doors 180 and 185. In some systems, the number of bottom doors may depend on the width of the grill system 100.

Bottom doors 180 and 185 may be made of the same materials as those of the side panel 387, or may be made of different materials. The bottom doors 180 and 185 may be located on one or more of a front portion of the grill system 100, a side portion of the grill system 100, a back portion of the grill system 100 and/or various other portions or combination of portions of the grill system 100.

The bottom doors 180 and 185 may be opened or closed. The bottom doors 180 and 185 may be used to access an interior bottom portion of the grill system. For example, the bottom doors 180 and 185 may be used to access an interior portion of the grill system 100 bounded by and/or identified by side panels, front panels, and/or back panels of a grill system frame 100. In some of these systems, the bottom doors 180 and 185 may be used to access a portion of the grill system 100 that may include the hopper 170 and/or cleanout pan 175. The bottom doors 180 and 185 may be opened and the cleanout pan 175 may be removed, such as for cleaning purposes. Other configurations and/or functions may be possible.

The grill system may include a vent 195. The vent 195 may, in some systems, be used to allow smoke and/or heat to leave the interior of the grill system 100. The vent 195 may be controlled so that a controlled level of smoke and/or heat may be released. The vent 195 may be one or more adjustable vents 195, which may be used for controlling smoke and/or influencing the temperature of a solid fuel fire. In some systems, the grill system 100 may not include a vent 195.

The grill system 100 may have various configurations. For example, a cooking surface 110 may be set, placed, configured and/or positioned above one or more solid fuel compartments 130 and 135. The solid fuel compartments 130 and 135 may be set, placed, configured, and/or positioned above one or more burner 140. For example, the solid fuel compartments 130 and 135 may cover and/or otherwise be arranged so as to lie directly above the burner 140. The burner 140 may be set, placed, configured, and/or positioned above one or more hoppers 170. For example, the hopper 170 may reside and/or otherwise be arranged so as to lie directly below the burner 140. The hopper 170 may be set, placed, configured, and/or positioned above one or more cleanout pans 175.

Other arrangements are possible. For example, one or more of the solid fuel compartments 130 and 135 may be set, placed, configured, and/or positioned below one or more burners 140. In other configurations, one or more of the solid fuel compartments 130 and 135 and/or burners 140 may be set, placed, configured, and/or positioned above the cooking surface 110. The solid fuel compartments 130 and 135 may or may not be positioned proximate to the cooking surface 110. Various other configurations are possible.

In some systems, the burner 140, the solid fuel compartments 130 and/or 135, and/or the cooking surface 110 may be vertically aligned with each other. In these configurations, heat and/or a flame from the burner 140 and heat and/or a flame from the solid fuel compartments 130 and 135 may both target and/or heat the same portion of the cooking surface 110. In some of these configurations, the cleanout bin 175 may be vertically aligned with the burner 140, the solid fuel compartments 130 and/or 135, and/or the cooking surface 110.

The grill system 100 may be designed, operable, configured, arranged, and/or utilized to cook foods using the burner 140, one or more solid fuel compartments 130 and 135, or both the burner 140 and the solid fuel compartments 130 and 135 without adjusting, modifying, changing, and/or altering an arrangement of the grill system 100. Various other configurations are possible.

The grill system 100 may be operable and/or used to cook foods in variety of ways. In some systems, the grill system 100 may be operable to cook foods using the burner 140. For example, fluid fuel may be accessed from the burner 140, such as using one or more of the knobs 154-159. Before, after, or at the same time, one or more of the ignition switches 153 may be activated, igniting the fluid fuel so that the fluid fuel is burning. An amount of fluid fuel accessed and burned, and/or a size of a flame, may be adjusted and/or modified using the knobs 154-159. The flame from the ignited and/or burning fluid fuel may heat a cooking surface 110 in the grill system 100. Food may be placed on the cooking surface 110 and cooked with the flame and/or heat from the ignited and/or burning fluid fuel. The solid fuel compartments 130 and 135 may be positioned in the grill system 100. The solid fuel compartments 130 and 135 may diffuse heat and/or a flame from the ignited and/or burning fluid fuel. An arrangement and/or configuration of the solid fuel compartments 130 and 135, such as an arrangement of a bottom panel 405 of the solid fuel compartments 130 and 135, may distribute and/or adjust the flame and/or heat from the ignited fluid fuel so that the heat and/or flame are evenly distributed over the cooking surface 110. Food may be cooked with the burner 140 without adjusting a configuration of the grill system 100, as the solid fuel compartments 130 and 135 may remain in the grill system 100 in the same position as when the solid fuel compartments 130 and 135 are used to cook the food. In at least these systems, for example, food may be grilled with the grill system 100 using a fluid fuel and/or the burner 140.

In some other systems, the grill system 100 may be operable to cook foods using one or more solid fuel compartments 130 and/or 135. For example, solid fuel may be placed and/or positioned in one or more of the solid fuel compartments 130 and 135. For example, a solid fuel compartment 130 and 135 may be slid out, like a drawer, from the grill system 100. Solid fuel may be placed in the slid out solid fuel compartment 130, after which, the solid fuel compartment 130 may be slid back into the grill system 100. A fluid fuel may be accessed from the burner 140. The fluid fuel may be ignited, such as with the ignition switches, and may heat and/or light solid fuel in the solid fuel compartments 130 and 135. Once the solid fuel is heated and/or ignited, in some systems, the fluid fuel may be turned off. In other systems, the solid fuel may be heated and/or ignited using a different heat and/or flame source, such as a lighter, matches, sparks, and/or other ignition or fire sources. Food may be placed on the cooking surface 110 and cooked with the heat and/or flame from the heated, ignited, and/or burning solid fuel. Food may be cooked, such as grilled and/or smoked, with heat and/or flame from the solid fuel in the solid fuel compartments 130 and 135. Ash from the solid fuel may be transported and/or fall through apertures in the solid fuel compartment 130 and 135, past the burner 140, and into the hopper 170 and/or cleanout pan 175. Cooking may be accomplished without adjusting a configuration of the grill system 100. In at least these systems, for example, food may be grilled and/or smoked with the grill system 100 using a solid fuel.

In some other systems, the grill system 100 may be operable to cook foods using both the burner 140 and one or more solid fuel compartments 130 and/or 135. For example, solid fuel may be placed and/or positioned in one or more of the solid fuel compartments 130 and 135. A fluid fuel may be accessed from the burner 140. The fluid fuel may be ignited, such as with the ignition switches, and may heat and/or light solid fuel in the solid fuel compartments 130 and 135. Food may be placed on the cooking surface 110 and may be cooked with the heat and/or flame from both the ignited fluid fuel and the ignited solid fuel. Food may be cooked with heat and/or flames from the burner 140 and the solid fuel compartments 130 and 135 without adjusting a configuration of the grill system 100. Cooking with both solid fuel and the fluid fuel may allow one to cook with less solid fuel, and/or infuse cooked food with flavors from solid fuels without requiring large amounts of solid fuel.

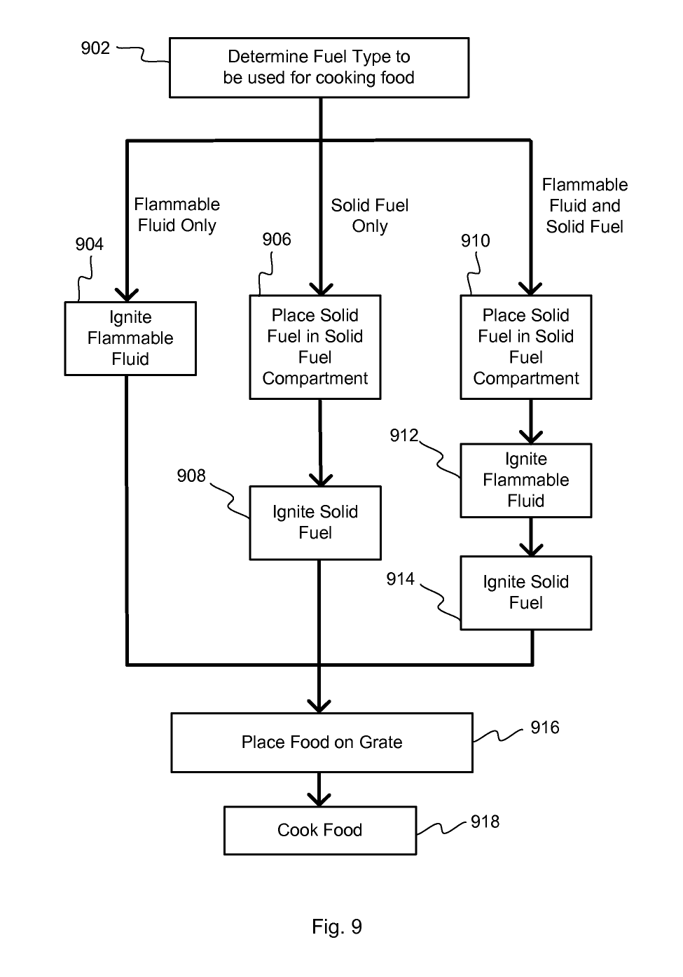

FIG. 9 illustrates a method of using the grill system 100 for cooking food. The method begins at block 902, where a determination is made as to what fuel type will be used for cooking food. Fuel types may include fluid fuels, such as natural gas, liquid propane, or other flammable gases or liquids, and solid fuels, such as charcoal or wood. Other fuel types may be possible.

Where only fluid fuels are to be used for cooking food, the method proceeds to block 904. At block 904, the fluid fuel is ignited. The fluid fuel may be ignited with the ignition switches 153, matches, a lighter, a spark, or various other ignition sources. The method may proceed to block 916, where food is placed on the cooking surface 110, such as on a portion of the cooking surface 110 above the burner 140 and/or ignited fluid fuel. At block 918, the food is then cooked.

Returning to block 902, where it is determined that only solid fuel will be used for cooking, the method may proceed to block 906. At block 906, solid fuel may be placed in one or more of the solid fuel compartments 130 and/or 135. For example, charcoal or wood pieces, such as wood pieces 490-494, may be placed in one or more solid fuel compartment.

The method may proceed to block 908, where the solid fuel may be ignited. This may be accomplished in a number of ways. For example, in some methods, fluid fuel from the burner 140 may be ignited, which in turn may ignite the solid fuel. Where the solid fuel is ignited in this manner, burning of the fluid fuel may be stopped, and/or use of the burner 140 may cease prior to moving from block 908 of the method. Alternatively, the solid fuel may be ignited in various other ways, such as with matches, a lighter, a spark, or various other ignition sources. While the method refers to igniting the solid fuel, in some embodiments, the solid fuel may alternatively or additionally be heated and/or burned.

From block 908, the method may proceed to block 916, where food is placed on the cooking surface 110, and block 918, where food is cooked. Blocks 916 and 918 may resemble and/or be the same as blocks 916 and 918 when only a fluid fuel is used for cooking.

Returning to block 902, where it is determined that both fluid fuel and solid fuel will be used for cooking, the method may proceed to block 910. In block 910, solid fuel may be placed in the solid fuel compartment. This block may resemble block 906 previously described.

Next, the method may proceed to block 912, where the fluid fuel may be ignited. This may resemble block 904 as previously discussed. The method may then proceed to block 914, where the solid fuel is ignited. The solid fuel may be ignited in a number of ways, such as with the ignited fluid fuel, or with matches, a lighter, a spark, or various other ignition sources. Unlike in block 908, however, the burner 140 and/or the fluid fuel in block 914 may remain in use and/or burning While the method shows the fluid fuel as being ignited after the solid fuel has been placed in the solid fuel compartment and prior to heating or ignition of the solid fuel, in some methods, the fluid fuel may be ignited before placing the solid fuel in the solid fuel compartment, simultaneously with ignition of the solid fuel, or after heating or ignition of the solid fuel.

After block 914, the method may proceed to block 916, where food is placed on the cooking surface 110. At this point, both the fluid fuel and the solid fuel may be ignited and/or burning. The method may then proceed to block 918, where the food is cooked.

Cooking may be accomplished with the grill system 100 using the burner 140 without using the solid fuel compartment 130 and/or without using solid fuel. The solid fuel compartment 130 may or may not diffuse heat from the burner 140 to provide even distribution of heat to the cooking surface 110. Cooking may be accomplished with the grill system 100 using solid fuel and the solid fuel compartment 130 without using the burner 140. Both the burner 140 and the solid fuel compartment 130 may operate during cooking, at the same time or at different times, without modifying an arrangement of the solid fuel compartment 130 and/or the burner 140. For example, the solid fuel compartment 130 and the burner 140 may heat a same portion of the cooking surface 110 at the same time or at different times during cooking.

Other systems and/or methods of cooking are possible. In one or more systems, waste may be created by heated and/or ignited solid fuels. For example, burning or burnt solid fuels may create ash. The ash from these burnt solid fuels may fall through apertures in the solid fuel compartments 130 and 135, and past the burners 140. This ash, or other waste, may fall into the hopper 170, and be funneled down into the cleanout pan 175, where it may be collected.

The grill system 100 may allow for cooking with fluid fuels, solid fuels, and/or both fluid fuels and solid fuels. The grill system 100 may be arranged, configured, and/or utilized to cook a piece of food using the solid fuel compartment 130, the burner 140, or both the solid fuel compartment 130 and the burner 140 without modifying an arrangement of the grill system 100. The cleanout pan 175 may be left in the grill system 100 below the burner 140, and may remain in the same position and mode of operation when food is cooked using either or both of the burner 140 and the solid fuel compartments 130 and 135. In some systems, as described, the grill system 100 may allow for cooking with solid fuel only, cooking with fluid fuel only, and cooking with both solid fuel and fluid fuel without modifying an arrangement of the grill system 100 and/or the solid fuel compartment 130 and burner 140. In other systems, the grill system 100 may allow for cooking with both solid fuel and fluid fuel, but may not allow for the option of cooking with solid fuel or fluid fuel only without modifying an arrangement of the grill system 100, the solid fuel compartment 130, and/or the burner 140.

The grill system 100 may have, be rated for, produce, and/or utilize various amounts of heat and/or cooking power. For example, some grill systems may have 115 British Thermal Units (BTUs) per square inch of primary cooking power. Various other amounts of heat and/or cooking power are possible.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A grill system comprising:
a grill frame;
a cooking surface attached to the grill frame;
a solid fuel compartment positioned proximate to the cooking surface; and
a burner positioned below the solid fuel compartment;
wherein cooking may be accomplished by alternately using only the burner, using only solid fuel placed in the solid fuel compartment, and using both the burner and the solid fuel placed in the solid fuel compartment to heat a common area of the cooking surface without modifying an arrangement of the solid fuel compartment and the burner.

2. The grill system of claim 1, further comprising a cleanout pan positioned below the burner.

3. The grill system of claim 1, wherein the solid fuel compartment and the burner operate at the same time.

4. The grill system of claim 1, wherein the solid fuel compartment comprises a drawer configured to hold charcoal or wood.

5. The grill system of claim 4, wherein the drawer comprises channels to hold the charcoal or wood.

6. The grill system of claim 4, wherein the drawer comprises a bottom that includes a plurality of circular apertures.

7. The grill system of claim 6, wherein the bottom further comprises a plurality of elongated slots.

8. The grill system of claim 1, wherein the solid fuel compartment diffuses heat from the burner to provide even distribution of heat to the cooking surface.

9. The grill system of claim 1, wherein the solid fuel compartment comprises two drawers positioned next to each other and above the burner.

10. The grill system of claim 1, wherein the burner comprises:
a gas port; and
a ledge positioned above the gas port to protect the gas port from waste created in the solid fuel compartment.

11. A grill system comprising:
a cooking surface;
a solid fuel compartment positioned below the cooking surface; and
a burner positioned below the solid fuel compartment;
wherein the solid fuel compartment is configured to hold solid fuel when cooking with the solid fuel, and to diffuse heat from the burner to provide uniform distribution of the heat to the cooking surface when cooking without solid fuel.

12. The grill system of claim 11, wherein the solid fuel compartment and the burner heat a same portion of the cooking surface during cooking.

13. The grill system of claim 11, wherein the solid fuel compartment comprises a drawer configured to hold charcoal or wood.

14. The grill system of claim 13, wherein the drawer comprises channels to hold the charcoal or wood.

15. The grill system of claim 13, wherein the drawer comprises a bottom that includes a plurality of circular apertures.

16. The grill system of claim 15, wherein the bottom comprises a plurality of elongated slots.

17. The grill system of claim 13, wherein the drawer comprises V-shaped channels extending from a front end of the drawer to a back end of the drawer.

18. The grill system of claim 17, further comprising elongated slots perpendicular to the V-shaped channels that each extend through a portion of at least one of the V-shaped channels.

19. A method of cooking, comprising:
providing a grill system that includes a cooking surface, a solid fuel compartment and a burner; and
providing for alternately cooking using only the burner, cooking using only solid fuel placed in the solid fuel compartment, and cooking using both the burner and the solid fuel placed in the solid fuel compartment, without modifying an arrangement of the solid fuel compartment and the burner.

20. The method of claim 19, further comprising:
providing for igniting the solid fuel using the burner.
